(19) United States
(12) Patent Application Publication
(10) Pub. No.: US 2013/0127706 A1
(43) Pub. Date: May 23, 2013

(54) METHOD FOR UNLOCKING SCREEN

(71) Applicant: ASUSTEK COMPUTER INC., TAIPEI (TW)

(72) Inventors: En-Wei HSU, TAIPEI (TW); Chun-Hsien LEE, TAIPEI (TW); Chun-Yi WANG, TAIPEI (TW)

(73) Assignee: ASUSTEK COMPUTER INC., TAIPEI (TW)

(21) Appl. No.: 13/663,607

(22) Filed: Oct. 30, 2012

Related U.S. Application Data
(60) Provisional application No. 61/561,262, filed on Nov. 18, 2011.

(51) Int. Cl. G06F 3/01

(52) U.S. Cl. 345/156

(57) ABSTRACT

A method for unlocking screen operable in an electronic apparatus having a screen is provided. The method includes, in a state that a display function of the screen is turned off, determining whether a trigger instruction received by the electronic apparatus corresponds to a trigger condition. If the trigger instruction corresponds to the trigger condition, in the state that the display function of the screen is turned off, determining whether an input instruction received by the electronic apparatus corresponds to an unlocking condition. If the input instruction corresponds to the unlocking condition, controlling the screen to turn on the display function thereof.

This application claims priority to US Provisional Application Ser. No. 61/561,262, filed Nov. 18, 2011, which is herein incorporated by reference.

### BACKGROUND

1. Technical Field

The present disclosure relates to a method for unlocking a screen.

2. Description of Related Art

Compared with a conventional way of operating a keyboard, the operating way of a touch screen is simpler and more intuitive. However, since a touch screen is sensitive, a portable electronic device associated with the touch screen may be unintentionally operated whenever a user inadvertently touches the touch screen. Therefore, the portable electronic apparatus is often provided a screen lock mode to prevent such unintended operation. If a user wants to use the portable electronic apparatus, he can't use it until unlocking the screen of the portable electronic apparatus.

### SUMMARY

The disclosure provides a method for unlocking a screen which is implemented by an electronic apparatus having a screen. The steps of the method are as follows, in a state that a display function of the screen is turned off, determining whether a trigger instruction received by the electronic apparatus corresponds to a trigger condition, If the trigger instruction correspond to the trigger condition, in the state that the display function of the screen is turned off, determining whether an input instruction received by the electronic apparatus corresponds to an unlocking condition. If the input instruction corresponds to the unlocking condition, controlling the screen turn on the display function thereof.

The method for unlocking a screen provided by the disclosure entails determining whether the input instruction received by the electronic apparatus corresponds to the predetermined unlocking condition in a state that the screen of the electronic apparatus is turned off, and the screen can be successfully unlocked when the input instruction is confirmed to correspond to the unlocking condition. In particular, a user must perform input of input signals according to a predetermined timing combination having different signal types to correspond to the unlocking condition. Through such processes, the method for unlocking a screen of the disclosure can be performed to unlock the screen without controlling the screen to show an unlocking image, so as to save power. Moreover, the method of the disclosure can effectively solve the problem of unintended unlocking of the screen when the user inadvertently touches the screen.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of an electronic apparatus according to an embodiment of the disclosure;

FIG. 2 is a flow diagram of a method for unlocking a screen according to an embodiment of the disclosure; and

FIG. 3 is a flow diagram of a method for unlocking a screen according to another embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

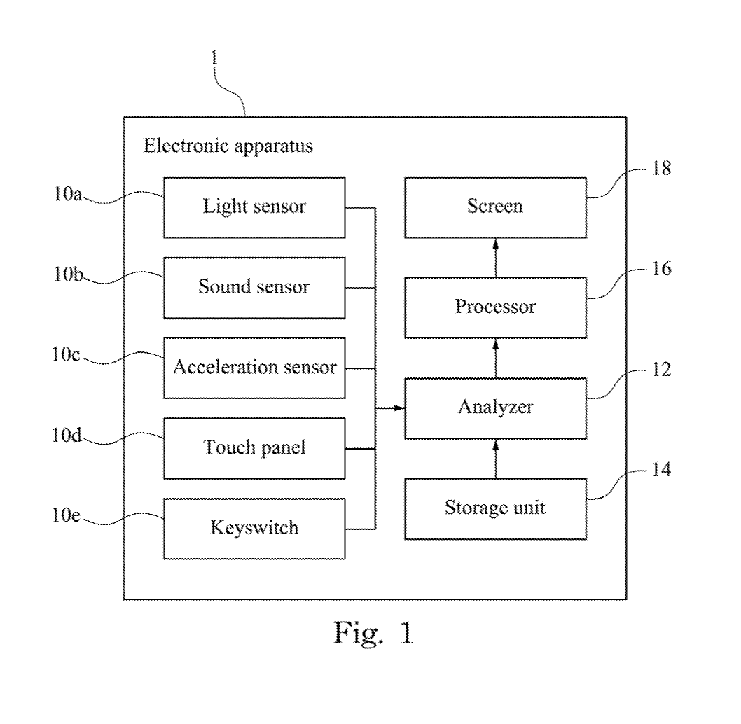

FIG. 1 is a block diagram of an electronic apparatus 1 according to an embodiment of the disclosure.

A method for unlocking a screen of the disclosure is implemented by the electronic apparatus 1. The electronic apparatus 1 can be a smart phone or a tablet PC, but the disclosure is not limited in this regard.

In the embodiment of the disclosure, the electronic apparatus 1 includes a light sensor 10a, a sound sensor 10b, an acceleration sensor 10c, a touch panel 10d, a keyswitch 10e, an analyzer 12, a storage module 14, a processor 16, and a screen 18.

The light sensor 10a, the sound sensor 10b, the acceleration sensor 10c, the touch panel 10d and the keyswitch 10e of the electronic apparatus 1 are electrically connected to the analyzer 12, and the analyzer 12 receives a light signal, a sound signal, an acceleration signal, a touch signal, and a button-triggering signal respectively from these input elements. It is noted that the input elements included in the electronic apparatus 1 are not limited to the different types listed herein. The analyzer 12 of the electronic apparatus 1 analyzes the signals received by the input elements.

In practice, before analyzing input signals that are in different formats, the formats of all the input signals must be converted into formats that can be analyzed by the analyzer 12. The conversion of the input signals having different formats can be achieved using software (e.g., a translation program) or hardware (e.g. a translator additionally installed in the electronic apparatus 1).

The storage unit 14 of the electronic apparatus 1 can be used to store an unlocking condition which can be pre-installed in the electronic apparatus 1 or set up by a user. Therefore, the analyzer 12 of the electronic apparatus 1 can analyze and compare the input signals received by the above-mentioned input elements with the unlocking condition in the storage module 14.

If the analyzer 12 of the electronic apparatus 1 determines that the input signals correspond to the unlocking condition, the processor 16 unlocks the screen 18. The method for unlocking a screen of the disclosure is realized through such a process.

However, the electronic apparatus 1 that implements the method of the disclosure is not limited in this regard. In order to achieve the purpose of unlocking a screen, in another embodiment of the disclosure, the electronic apparatus 1 may include only one of the light sensor 10a, the sound sensor 10b, the acceleration sensor 10c, the touch panel 10d, and the keyswitch 10e. Furthermore, in order to make it more difficult to unlock a screen through an inadvertent touch, in another embodiment of the disclosure, the electronic apparatus 1 includes at least two of the light sensor 10a, the sound sensor 10b, the acceleration sensor 10c, the touch panel 10d, and the keyswitch 10e.

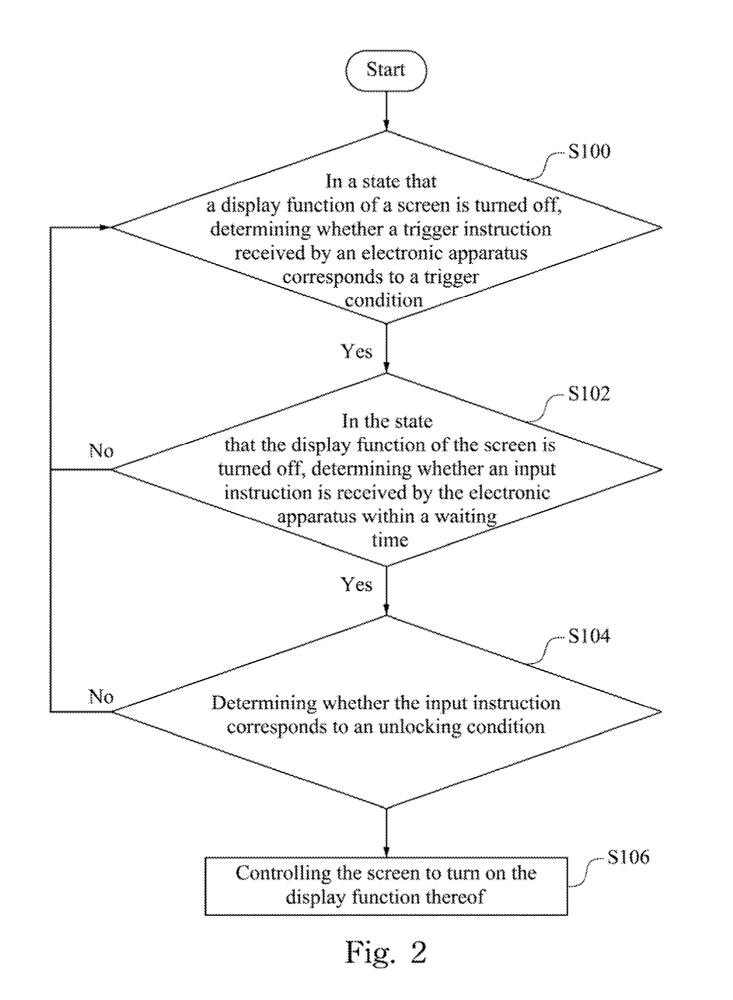

FIG. 2 is a flow diagram of a method for unlocking a screen according to an embodiment of the disclosure.

The method for unlocking a screen according to an embodiment of the disclosure will now be described with reference to FIG. 1 and FIG. 2. The method of the disclosure includes steps S100˜S106.

First, in step S100, in a state that a display function of the screen 18 is turned off, a determination is made as to whether a trigger instruction received by the electronic apparatus 1 corresponds to a trigger condition. If the trigger instruction corresponds to the trigger condition, step S102 of the method is subsequently executed.

In the embodiment of the disclosure, the trigger condition can be a luminance change command, a sound command, an acceleration command, a touch command, or a button-click command. That is, the user may perform an action to generate a trigger instruction, which is then compared with the trigger condition to determine whether the trigger instruction corresponds to the trigger condition.

For example, a trigger instruction that corresponds to the luminance change command may be that generated when the user makes the light sensor 10a of the electronic apparatus 1 sense a change of luminance (e.g., by blocking light from the electronic apparatus 1). Moreover, a trigger instruction that corresponds to the sound command may be that generated when the user makes the sound sensor 10b sense a change of volume (e.g., by speaking or singing to the electronic apparatus 1). Additionally, a trigger instruction that corresponds to the acceleration command may be that generated when the user makes the acceleration sensor 10c of the electronic apparatus 1 sense a change of acceleration (e.g., by patting, jerking, or flipping over the electronic apparatus 1). Also, a trigger instruction that corresponds to the touch command may be that generated when the user makes the touch panel 10d of the electronic apparatus 1 sense the touch of the user. Finally, a trigger instruction that corresponds to the button-click command may be that generated when the user makes the keyswitch 10e of the electronic apparatus 1 sense button pressing by the user. In some embodiments, it may be possible to select the trigger condition according to the preferences of the user, but the disclosure is not limited in this regard. In practice, the trigger condition can be stored in the storage module 14, and the analyzer 12 of the electronic apparatus 1 can determine whether the trigger instruction corresponds to the trigger condition stored in the storage module 14.

According to the method of the disclosure, the electronic apparatus 1 starts to analyze and compare an input instruction subsequently inputted by the user only after determining that the trigger instruction corresponds to the trigger condition. Therefore, the problem of unintentional unlocking of the screen when the user inadvertently touches the screen can be effectively solved.

Next, in step S102, in the state that the display function of the screen 18 is turned off, a determination is made as to whether an input instruction is received by the electronic apparatus 1 within a waiting time. If an input instruction is received within the waiting time, step S104 of the method is subsequently executed.

In the embodiment of the disclosure, if continuous detecting to determine whether the user inputs an input instruction is performed after the trigger instruction is determined to correspond with the trigger condition, the electronic apparatus 1 will consume power very fast. Therefore, in the method of the disclosure, the electronic apparatus 1 sets a waiting time (e.g., 10 seconds). The electronic apparatus 1 starts to analyze and compare the input instruction of the user with the unlocking condition only if the input instruction is received within the waiting time.

On the other hand, if it is determined in step S102 that an input instruction is not received within the waiting time, step S100 of the method is executed again.

It is noted, however, that if the problem of power consumption of the electronic apparatus 1 does not need to be taken into consideration, in another embodiment of the disclosure, step S102 can be omitted.

In step S104, a determination is made as to whether the input instruction corresponds to the unlocking condition. If the input instruction corresponds to the unlocking condition, step S106 of the method is subsequently executed. if the input instruction does not correspond to the unlocking condition, step S100 of the method is executed again.

It should be pointed out that, in some embodiments, one of technical features is that the unlocking condition includes inputting M input signals according to a first rhythm, in which the M input signals include N signal types.

Both M and N are integers larger than 1. That is, in this embodiment of the disclosure, in order to successfully unlock the screen 18, the input instruction inputted by the user must be such that the M input signals are inputted according to the first rhythm, and the N signal types of the M input signals must include at least one of the light signal, the sound signal, the acceleration signal, the touch signal, and the button-triggering signal (i.e., the M input signals must include at least one of the signal types).

However, in order to make it more difficult to unlock a screen through an inadvertent touch, in another embodiment of the disclosure, N is an integer larger than 1, and M is an integer equal to or larger than N. That is, in this embodiment of the disclosure, in order to successfully unlock the screen 18, the input instruction inputted by the user must be such that the M input signals are inputted according to the first rhythm, and the N signal types of the M input signals must include at least two of the light signal, the sound signal, the acceleration signal, the touch signal, and the button-triggering signal (i.e., the M input signals must include at least two of the signal types).

The unlocking condition can be set up by the user and stored in the storage module 14 of the electronic apparatus 1.

In an embodiment of the disclosure, the unlocking condition further includes setting values of duration corresponding to the M input signals respectively (i.e., the durations of the M input signals can be the same or different). For example, the input instruction can correspond to the unlocking condition when the user inputs three long sound signals and two short sound signals according to the first rhythm to the electronic apparatus 1 via the sound sensor 10b or inputs touch signals in a command according to the first rhythm to the electronic apparatus 1 via the touch panel 10d, but the disclosure is not limited in this regard. Through use of such a process, the method of the disclosure can effectively solve the problem of unintentional unlocking of the screen when the user inadvertently touches the screen.

In an embodiment of the disclosure, the unlocking condition further comprises setting values of signal strength corresponding to the M input signals respectively (i.e., the signal strengths of the M input signals can be the same or different). For example, the input instruction can correspond to the unlocking condition when the user inputs correct bright light signal(s) and dark light signal(s) according to the first rhythm to the electronic apparatus 1 via the light sensor 10a, inputs loud sound signal(s) and quiet sound signal(s) according to the first rhythm to the electronic apparatus 1 via the sound sensor 10b, or inputs touch signals with correct strengths according to the first rhythm to the electronic apparatus 1 via the touch panel 10d, but the disclosure is not limited in this regard. Through use of signal strength in such a manner, the method of the disclosure can effectively solve the problem of unintentional unlocking of the screen when the user inadvertently touches the screen.

Moreover, the first rhythm includes a plurality of rhythm combinations, and each of the rhythm combinations corresponds to at least one of the M input signals. In an embodiment of the disclosure, the rhythm combinations correspond to the M input signals respectively. In other words, the first rhythm includes M rhythm combinations, and each of the rhythm combinations corresponds to one of the M input signals. In this case, the input instruction corresponds to the unlocking condition only if the M input signals are inputted sequentially (not simultaneously) according to the rhythm combinations of the first rhythm.

In another embodiment of the disclosure, at least two of the M input signals correspond to one of the rhythm combinations of the first rhythm, and the two input signals respectively belong to two of the above-mentioned signal types. For example, the input instruction will correspond to the unlocking condition if, during a certain timing segment of the first rhythm, the user blocks light and sings to the electronic apparatus 1 at the same time, blocks light to the light sensor 10a and touches the touch screen 10d at the same time, or blocks light to the light sensor 10a and presses the keyswitch 10e at the same time. However, the disclosure is not limited to such examples.

In an embodiment of the disclosure, the unlocking condition further includes setting values of time intervals between adjacent rhythm combinations of the first rhythm. In other words, the time intervals between adjacent rhythm combinations can be the same or different. As a result, the first rhythm may not include a constant value of TPM (Timing Per Minute). Through use of such time intervals, the method of the disclosure can effectively solve the problem of unintentional unlocking of the screen when the user inadvertently touches the screen.

Finally, in Step S106, the screen 18 is controlled to turn on the display function thereof.

It should be pointed out that the processor 16 controls the screen 18 to turn on the display function thereof after the analyzer 12 confirms that the input instruction inputted by the user corresponds to the unlocking condition. Therefore, it is unnecessary for the electronic apparatus 1 to show an unlocking image on the screen 18, and thus, power savings can be realized.

However, if the problem of power consumption of the electronic apparatus 1 does not need to be taken into consideration, the screen 18 of the electronic apparatus 1 can be turned on and display whether the input of the input instruction by the user is successful or not. At this time, the screen 18 is not in an unlocked state. After the analyzer 12 of the electronic apparatus 1 confirms that the input instruction inputted by the user is corresponds to the unlocking condition, the processor 16 unlocks the screen 18 and makes the screen 18 turn on the display function.

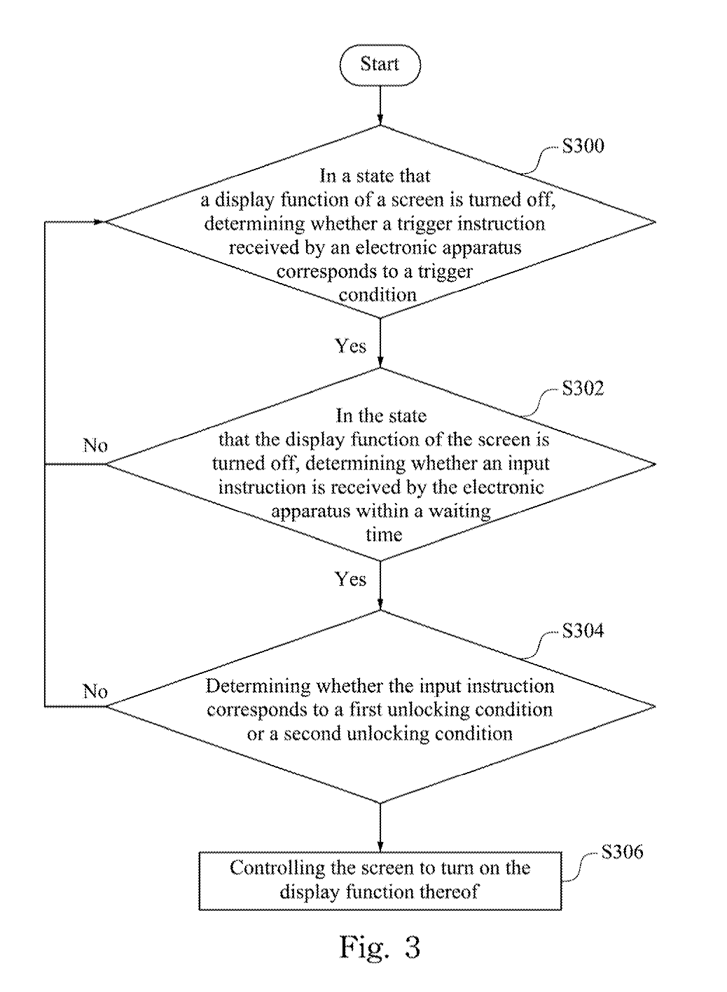

FIG. 3 is a flow diagram of a method for unlocking a screen according to another embodiment of the disclosure.

The method for unlocking a screen according to another embodiment of the disclosure will now be described with reference to FIG. 1 and FIG. 3. The method for unlocking a screen according to this embodiment includes steps S300˜S306.

First, in Step S300, in a state that the display function of the screen 18 is turned off, a determination is made as to whether a trigger instruction received by the electronic apparatus 1 corresponds to a trigger condition. If the trigger instruction corresponds to the trigger condition, step S302 of the method is subsequently executed.

In Step S302, in the state that the display function of the screen 18 is turned off, a determination is made as to whether an input instruction is received by the electronic apparatus 1 within a waiting time. If an input instruction is received within the waiting time, step S304 of the method is subsequently executed. If, on the other hand, it is determined in step S302 that an input instruction is not received within the waiting time, step S300 of the method is executed again.

Subsequently, in Step S304, a determination is made as to whether the input instruction corresponds to a first unlocking condition or a second unlocking condition. If the input instruction corresponds to the first unlocking condition or the second unlocking condition, Step S306 of the method is subsequently executed. On the other hand, if the input instruction does not correspond to the first unlocking condition or the second unlocking condition, step S300 of the method is executed again.

Finally, in Step S306, the screen 18 is controlled to turn on the display function thereof.

It should be pointed out that compared with the embodiment described with reference to FIG. 2, one of technical features of this embodiment is that the first unlocking condition includes inputting M input signals according to a first rhythm and the second unlocking condition includes inputting P input signals according to a second timing combination, in which the M input signals include N signal types and the P input signals include Q signal types. Both M and N are integers larger than 1, and both P and Q are integers larger than 1. That is, in this embodiment of the disclosure, in order to successfully unlock the screen 18, the input instruction inputted by the user must be such that the M input signals are inputted according to the first rhythm, and the N signal types of the M input signals must include at least one of the light signal, the sound signal, the acceleration signal, the touch signal, and the button-triggering signal (i.e., the M input signals must include at least one of the signal types). Alternatively, in order to successfully unlock the screen 18, the input instruction inputted by the user must be such that the P input signals are inputted according to the second timing combination, and the Q signal types of the P input signals must include at least one of the light signal, the sound signal, the acceleration signal, the touch signal, and the button-triggering signal (i.e., the P input signals must include at least one of the signal types).

However, in order to make it more difficult to unlock a screen through an inadvertent touch, in another embodiment of the disclosure, N is an integer larger than 1, and M is an integer equal to or larger than N. That is, in this embodiment of the disclosure, in order to successfully unlock the screen 18, the input instruction inputted by the user must be such that the M input signals are inputted according to the first rhythm, and the N signal types of the M input signals must include at least two of the light signal, the sound signal, the acceleration signal, the touch signal, and the button-triggering signal (i.e., the M input signals must include at least two of the signal types). Alternatively, in another embodiment of the disclosure, Q is an integer larger than 1, and P is an integer equal to or larger than N. That is, in this embodiment of the disclosure, in order to successfully unlock the screen 18, the input instruction inputted by the user must be such that the P input signals are inputted according to the second timing combination, and the Q signal types of the P input signals must include at least two of the light signal, the sound signal, the acceleration signal, the touch signal, and the button-triggering signal (i.e., the P input signals must include at least two of the signal types).

The first unlocking condition and the second unlocking condition can be set up by the user and stored in the storage module 14 of the electronic apparatus 1, Moreover, the signal types included in the M input signals and the signal types included in the P input signals can be the same, partially the same, or totally different.

Therefore, the condition of step S304 can be determined to be satisfied when the input instruction inputted by the user corresponds to the first unlocking condition or the second unlocking condition. However, the disclosure is not limited in this regard. The number of unlocking conditions stored in the storage module 14 of the electronic apparatus 1 can be adjusted as needed.

In an embodiment of the disclosure, the second unlocking condition can further include setting values of duration corresponding to the P input signals respectively, setting values of signal strength corresponding to the P input signals respectively, and setting values of time intervals between adjacent rhythm combinations of the second timing combination. Reference can be made to the related descriptions of the unlocking condition in the above embodiment. Therefore, an explanation in this regard will not be repeated.

Furthermore, Steps S300˜S306 are similar to Steps S100˜S106, and so reference can be made to the related descriptions of Steps S100˜S106 for additional details related to steps S300˜S306, and an explanation in this regard will not be repeated.

According to the foregoing recitations of the embodiments of the disclosure, it can be seen that the method for unlocking a screen of the disclosure entails determining whether the input instruction received by the electronic apparatus corresponds to the predetermined unlocking condition in a state that the screen of the electronic apparatus is turned off, and the screen can be successfully unlocked when the input instruction is confirmed to correspond to the unlocking condition. In particular, a user must perform input of input signals according to a predetermined timing combination having different signal types to correspond to the unlocking condition. Through such processes, the method for unlocking a screen of the disclosure can be performed to unlock the screen without controlling the screen to show an unlocking image, so as to save power. Moreover, the method of the disclosure can effectively solve the problem of unintended unlocking of the screen when the user inadvertently touches the screen.

It will be apparent to those skilled in the art that various modifications and to variations can be made to the structure of the present disclosure without departing from the scope or spirit of the disclosure. In view of the foregoing, it is intended that the present disclosure cover modifications and variations of this disclosure provided they fail within the scope of the following claims.

What is claimed is:

1. A method for unlocking a screen implemented by an electronic apparatus having a screen, the method comprising:
in a state that a display function of the screen is turned off, determining whether a trigger instruction received by the electronic apparatus corresponds to a trigger condition;
if the trigger instruction corresponds to the trigger condition, in the state that the display function of the screen is turned off, determining whether an input instruction received by the electronic apparatus corresponds to an unlocking condition; and
if the input instruction corresponds to the unlocking condition, controlling the screen to turn on the display function thereof.

2. The method of claim 1, wherein the unlocking condition is inputting M input signals according to a first rhythm, the M input signals comprise N signal types, and both M and N are integers larger than 1.

3. The method of claim 2, wherein the unlocking condition further comprises setting values of duration corresponding to the M input signals respectively.

4. The method of claim 2, wherein the unlocking condition further comprises setting values of signal strength corresponding to the M input signals respectively.

5. The method of claim 2, wherein the unlocking condition further comprises setting values of time intervals between adjacent rhythm combinations of the first rhythm.

6. The method of claim 2, wherein the N signal types comprise at least two of a light signal, a sound signal, an acceleration signal, a touch signal, and a button triggering signal.

7. The method of claim 1, further comprising, between determining that the trigger instruction received by the electronic apparatus corresponds to the trigger condition and determining that the input instruction received by the electronic apparatus corresponds to the unlocking state:
in the state that the display function of the screen is turned off, determining whether the electronic apparatus receives the input instruction within a waiting time;
wherein determining whether the input instruction corresponds to the unlocking condition is performed in response to determining that the electronic apparatus receives the input instruction within the waiting time.

8. The method of claim 1, wherein the trigger condition is a luminance change command, a sound command, an acceleration command, a touch command, or a button-click command.
